(19) United States
(12) Patent Application Publication
(10) Pub. No.: US 2007/0185981 A1
(43) Pub. Date: Aug. 9, 2007

(54) POWER LINE COMMUNICATION APPARATUS AND POWER LINE COMMUNICATION SYSTEM

(75) Inventors: Hisao Koga, Fukuoka (JP); Takao Gondo, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/673,339

(22) Filed: Feb. 9, 2007

(30) Foreign Application Priority Data
Feb. 9, 2006 (JP) 2006-032484

(51) Int. Cl. G06F 15/177; G06F 15/16; G06F 17/00

(52) U.S. Cl. 709/222; 709/249; 713/1; 235/375

(57) ABSTRACT

Power line communication apparatuses 100a, 100x each is equipped with a power line communication unit connected to a power line, for performing a power line communication; RFID tag 50a, 50x for storing thereinto communication setting information employed when a communication is carried out in the power line communication unit; and RFID tag reader 40a, 40x having an antenna, for reading out the information stored in the RFID tag 50a, 50x by employing a wireless communication. The power line communication apparatus 100a reads out the communication setting information of the power line communication apparatus 100x from the RFID tag 50x, and performs the power line communication with the power line communication apparatus 100x based upon the communication setting information.

### BACKGROUND

The present invention is related to a power line communication apparatus and a power line communication system.

For instance, in the case where data communications are carried out in wired manners in homes, offices, factories, and the like by employing terminals such as computers, wiring lines (namely, cables and connectors) used as transmission paths are normally required to be installed at necessary places. As a result, there is no way other than that various sorts of constructions should be carried out until operations of communication facilities are commenced.

On one hand, commercial power supplies of, for example, AC 120 V (60 Hz) and 100 V (50/60 Hz) are utilized in most places of these homes, offices, and factories. As a result, electric power lines (electric light lines) employed to supply the above-described electric power have already been installed at any places within the homes, offices, and factories. As a consequence, if these power lines can also be utilized in data communications, then specific wiring lines for data communication purposes need not be newly installed. In other words, communication paths may be secured by merely inserting communication apparatuses into plug sockets of these commercial power supplies.

With respect to technical ideas of power line communications (PLCs) in which the above-explained power lines are utilized in communications, such a technical idea disclosed in, for example, JP-A-2000-165304 is known.

On the other hand, in a network of the above-described power line system, or the like, when a communication apparatus is newly connected to this network, various sorts of setting operations are necessarily required, for instance, the new communication apparatus is registered to the network, security authentication is carried out, and the like.

As the above-described setting method, one setting method may be conceived, namely, a personal computer, or the like is connected to this network in order to set the new communication apparatus. However, the setting operation by using the personal computer must be carried out after a user could understand the setting method. Accordingly, there are some problems that the sequential operations for setting the communication become cumbersome.

### SUMMARY

The below-mentioned embodiments have been made to solve the above-described problems, and therefore, the present invention has an object to provide a power line communication apparatus and a power line communication system, capable of readily setting a power line communication.

A power line communication apparatus, according to the invention, comprises: a power line communication unit for performing a power line communication via a power line; and a near-field communication unit for performing a near-field communication by employing any one of electromagnetic waves and a magnetic field; in which the near-field communication unit includes a memory for storing thereinto communication setting information which is employed in authentication with respect to another power line communication apparatus.

With employment of the above-explained arrangement, since the communication setting information is stored in the near-field communication unit, the power line communication apparatus to which the communication setting operation must be carried out can acquire the communication setting information by employing a reader so as to perform the communication setting operation, while the reader can read data from the near-field communication apparatus by employing, for instance, a wireless communication. As a result, the power line communication apparatus can easily set the power line communication operation without operating a personal computer, and the like.

Also, a power line communication apparatus, according to the invention, comprises: a reader having an antenna, for reading information stored in a near-field communication unit via the antenna by way of a near-field communication using any one of electromagnetic waves and a magnetic field; and a power line communication unit for performing a power line communication via a power line; in which when communication setting information related to another power line communication apparatus is read by the reader from a near-field communication unit mounted on the another power line communication apparatus, the power line communication unit performs a power line communication operation with respect to the another power line communication apparatus based upon the read communication setting information.

With employment of the above-explained arrangement, the near-field communication unit into which the communication setting information has been stored is mounted on the power line communication apparatus to which the communication setting operation must be carried out. As a result, the power line communication apparatus can acquire the communication setting information by employing a reader so as to perform the communication setting operation, while the reader can read data from the near-field communication apparatus by employing, for instance, a wireless communication. As a consequence, the power line communication apparatus can easily set the power line communication operation without operating a personal computer, and the like.

Further, a power line communication system, according to the invention, comprises: a first power line communication apparatus and a second power line communication apparatus, which perform a power line communication operation via a power line; wherein: the first power line communication apparatus is comprised of: a first power line communication unit for performing a power line communication operation via the power line; and a near-field communication unit for storing thereinto communication setting information which is employed when the first power line communication unit performs the power line communication operation; and wherein: the second power line communication apparatus is comprised of: a reader having an antenna, for reading information stored in the near-field communication unit via the antenna by employing a wireless communication operation; and a second power line communication unit for performing a power line communication operation via the power line; when the communication setting information employed in such a case that the first power line communication apparatus performs the power line communication operation is read out from the near-field communication unit mounted on the first power line communication apparatus by the reader, the second power line communication unit performs the power line communication operation with the first power line communication apparatus based upon the communication setting information.

With employment of the above-described arrangement, in the power line communication system, while the communication setting information is stored, the communication setting information is acquired from the near-field communication unit by employing the reader, and the communication setting operation can be carried out. As a result, the power line communication setting operation can be readily carried out.

The power line communication apparatus and the power line communication system, capable of readily setting the power line communications, can be provided.

### BRIEF DESCRIPTION OF THE DRAWINGS

FIG. 1 is an explanatory diagram for indicating an outline of a power line communication system according to an embodiment mode of the present invention.

FIG. 2 is an explanatory diagram for indicating another example of an outline of a power line communication system according to the embodiment mode of the present invention.

FIG. 3 is a block diagram for showing a major functional structure of the power line communication apparatus according to the embodiment mode.

FIG. 4 is a block diagram for indicating a major functional structure of an RFID reader and an RFID tag employed in the power line communication apparatus according to the embodiment mode.

FIG. 5 is a sequential diagram for representing an outline of an authentication processing operation executed in the embodiment mode.

FIG. 6 is a diagram for representing a first example of process sequential operations for acquiring setting information with employment of the RFID tag reader in the embodiment mode.

FIG. 7 is a diagram for representing a second example of process sequential operations for acquiring setting information with employment of the RFID tag reader in the embodiment mode.

FIG. 8 is a diagram for showing one example as to a frequency characteristic of a power line communication signal when the RFID tag is initiated.

FIG. 9 is a sequential diagram for showing a first concrete example of the authentication process operations executed in the embodiment mode.

FIG. 10 is a sequential diagram for indicating a second concrete example of the authentication process operations executed in the embodiment mode.

FIG. 11 is a sequential diagram for showing a third concrete example of the authentication process operations executed in the embodiment mode.

FIG. 12 is a sequential diagram for indicating a fourth concrete example of the authentication process operations executed in the embodiment mode.

FIG. 13 is a block diagram for representing one example as to hardware of the power line communication apparatus according to the embodiment mode.

### DETAILED DESCRIPTION

It should be understood that the below-mentioned description is made of such a case that a power line communication system is provided with a power line communication apparatus 100a which is operated as a master apparatus, and another power line communication apparatus 100x which is operated as a slave apparatus.

Also, the power line communication apparatuses 100a and 100x correspond to such communication apparatuses which employ a power line as a transmission path. As one example, these power line communication apparatuses 100a and 100x arranged as modems will be explained. It should also be understood that the power line communication apparatuses need not be arranged as the modems, but may be alternatively arranged as electronic appliances equipped with modems. Also, as a power line communication, a broad-band communication of a multi-carrier communication system (for instance, frequencies of 2 to 20 MHz) will now be described. It should also be noted that a communication band is not specifically limited only to 2 to 30 MHz, but may be arbitrarily selected, for example, a frequency band of 1.7 MHz to 80 MHz may be alternatively selected.

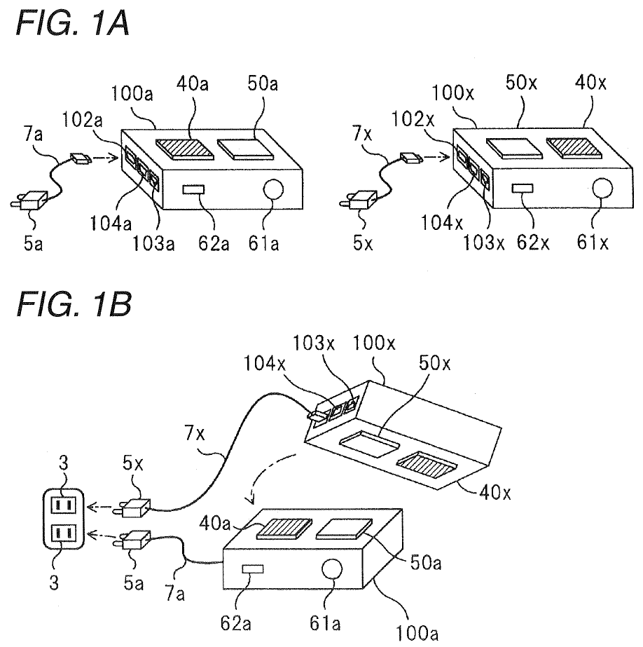

As represented in FIG. 1A, the power line communication apparatus 100a is equipped with an RFID (Radio Frequency Identification) tag reader 40a, an RFID tag 50a, an operation unit 61a, and a display unit 62a. A power supply connector 102a, a LAN (Local Area Network)-purpose modular jack 103a such as RJ45, and a D-SUB connector 104a are provided on an outer surface of the communication apparatus 100a. An AC power supply cord 7a such as a parallel cable is connected to the power supply connector 102a. A LAN cable (not shown) is connected to the modular jack 103a. AD-SUB cable (not shown) is connected to the D-SUB connector 104a. Then, the communication apparatus 100a has such a structure that the own communication apparatus 100a is connectable to a power line via a power supply plug 5a connected to the AC power supply cord 7a.

Similarly, the power line communication apparatus 100x is equipped with an RFID tag reader 40x, an RFID tag 50x, an operation unit 61x, and a display unit 62x. A power supply connector 102x, a LAN (Local Area Network)-purpose modular jack 103x such as RJ45, and a D-SUB connector 104x are provided on an outer surface of the communication apparatus 100x. An AC power supply cord 7x such as a parallel cable is connected to the power supply connector 102x. A LAN cable (not shown) is connected to the modular jack 103x. A D-SUB cable (not shown) is connected to the D-SUB connector 104x. Then, the communication apparatus 100x has such a structure that the own communication apparatus 100x is connectable to a power line via a power supply plug 5x connected to the AC power supply cord 7x.

It should also be understood that the power line communication apparatuses 100a and 100x, the RFID tag readers 40a and 40x, the RFID tags 50a and 50x, the operation units 61a and 61x, the display units 62a and 62x, the AC power supply cords 7a and 7x, the power supply plugs 5a and 5x, the power supply connectors 102a and 102x, the modular jacks 103a and 103x, and the D-SUB connectors 104a and 104x have the similar functions respectively. As a result, when the master apparatus and the slave apparatus need not be discriminated from each other, these reference numerals will be explained as follows: a power line communication apparatus 100; an RFID tag reader 40; an RFID tag 50; an operation unit 61; a display unit 62; an AC power supply cord 7; a power supply plug 5; a power supply connector 102; a modular jack 103; and a D-SUB connector 104.

An RFID is one example of a wireless communication medium. A “wireless communication medium” described in the present specification implies such a communication medium which is equipped with a loop antenna, and performs a near-field (proximity) communication by utilizing either electromagnetic waves or magnetic fields via the loop antenna. A “near-field communication” implies a wireless communication over a short distance by employing electromagnetic waves or magnetic fields. As a frequency band of the electromagnetic waves employed in the near-field communication, an UHF band (for example, 900 MHz) is used, whereas as a frequency band of the magnetic fields, an HF band (for example, 13.56 MHz) is employed. As a mode of the wireless communication medium, there are such modes such as a semiconductor IC (Integrated Circuit), and a non-contact IC card. An RFID may also be called as an IC tag, an RF tag, a non-contact tag, a non-contact IC tag, and the like.

While the RFID tag reader 40 has an antenna 42, the RFID tag reader 40 reads information stored in the RFID tag 50 via the antenna 42 by employing a wireless communication. The RFID tag 50 corresponds to one example of the wireless communication medium, and stores thereinto communication setting information which is employed when a power line communication is carried out. The operation unit 61 contains push buttons and the like, and, for instance, the operation unit 61 enters an instruction to start a communication setting operation by depressing the push button. The display unit 62 is constructed by containing, for example, an LED (Light Emitting Diode), and the like, and turns ON the LED in response to a condition when the communication setting operation is carried out.

It should also be noted that “communication setting information” described in the present specification corresponds to various sorts of information which are used when a power line communication is carried out, and implies such an information used in authentication executed between two sets of power line communication apparatuses except for actual data (for example, image data, voice data, and text data) which are actually communicated. As an example of the communication setting information, there are address information (for instance, MAC address), information related to authentication, and the like.

As indicated in FIG. 1B, when a communication setting operation is carried out, the power supply plugs 5a and 5x are inserted into a plug socket 3 so as to initiate the power line communication apparatuses 100a and 100x. Then, both the power line communication apparatus 100a and the power line communication apparatus 100x are approached to each other in such a manner that the RFID tag readers 40 are located in proximity to the RFID tags 50 with each other.

The power line communication apparatus 100a acquires the communication setting information stored in the RFID tag 50x of the power line communication apparatus 100x by employing the RFID tag reader 40a, whereas the power line communication apparatus 100x acquires the communication setting information stored in the RFID tag 50a of the power line communication apparatus 100a by employing the RFID tag reader 40x. Then, the power line communication apparatuses 100a and 100x perform authentication by employing the acquired communication setting information so as to perform a communication connection.

As represented in FIG. 1B, in such a case that both the power line communication apparatus 100a operated as the master apparatus and the power line communication apparatus 100x operated as the slave apparatus are operated as master apparatuses, when the power line communication apparatuses 100a and 100x are directed to the same direction, it is preferable to provide these power line communication apparatuses 100a and 100x at such positions opposite to each other. In other words, in such a case where the RFID tag reader 40a is installed at a first position and the RFID tag 50a is installed at a second position which is different from the first position in the power line communication apparatus 100a, the RFID tag reader 40x is installed at the second position and the RFID tag 50x is installed at the first position in the power line communication apparatus 100x. As a consequence, since the power line communication apparatuses 100a and 100x are approximated to each other with being directed to the same direction, these power line communication apparatuses 100a and 100x can firmly read out the communication setting information from the RFID tag 50. Alternatively, it is also possible to avoid that communication setting process operations are carried out by the master apparatuses with each other, or by the slave apparatuses with each other.

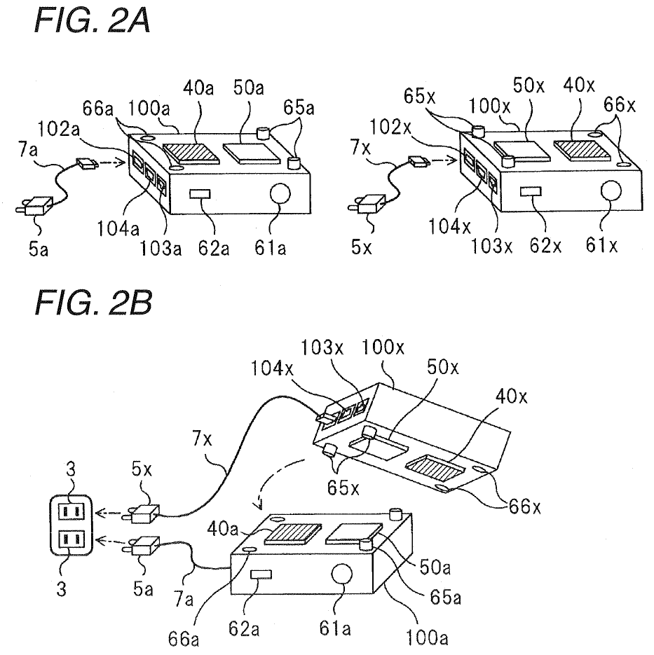

As shown in FIG. 2A, a convex portion 65a and a concave portion 66a have been provided on an outer surface of a housing of the power line communication apparatus 100a. Similarly, a convex portion 65x and a concave portion 66x have been provided on an outer surface of a housing of the power line communication apparatus 100x.

It should also be noted that both the convex portion 65 and the concave portion 66 are installed at such positions which own a predetermined relationship with the positions where the RFID tag reader 40 and the RFID tag 50 have been mounted. Then, the convex portion 65 and the concave portion 66 may function as identifying portions capable of recognizing from an external area that the RFID tag reader 40 and the RFID tag 50 have been mounted on which positions. Also, as shown in FIG. 2B, the power line communication apparatus 100 can position the RFID tag reader 40 and the RFID tag 50 opposite to each other in a correct mode by directing the planes of the convex portions 65 and the concave portions 66 in such a manner that the convex portion 65a of the power line communication apparatus 100a is located opposite to the concave portion 66x of the power line communication apparatus 100x, and also, the concave portion 66a of the power line communication apparatus 100a is located opposite to the convex portion 65a of the power line communication apparatus 100x.

It should also be noted that in FIG. 1 and FIG. 2, such an example is illustrated, namely, the RFID tag reader 40 and the RFID tag 50 have been provided on the outer surface of the housing of the power line communication apparatus 100. Alternatively, the RFID tag reader 40 and the RFID tag 50 may be provided within the housing. Also, the identifying portions indicative of the RFID tag reader 40 and the RFID tag 50 may not be realized as the convex portions 65 and the concave portions 66, but also characters, symbols, and the like may be alternatively indicated on the outer surface of the housing.

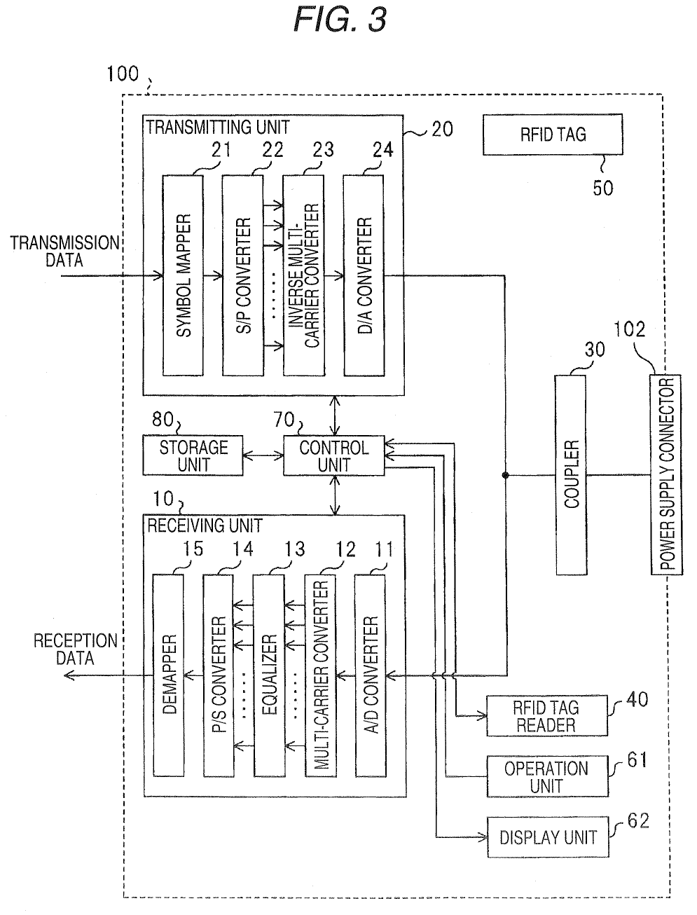

As indicated in FIG. 3, the power line communication apparatus 100 is equipped with a receiving unit 10, a transmitting unit 20, a coupler 30, an RFID tag reader 40, an RFID tag 50, an operation unit 61, a display unit 62, a control unit 70, and a storage unit 80. Also, the power line communication apparatus 100 is equipped with a power supply connector 102 which is employed so as to be connected to the AC power supply cord 7. It should also be noted that the receiving unit 10, the transmitting unit 20, the coupler 30, and the control unit 70 are connected to a power line so as to be operated as one example of a power line communication unit which performs a power line communication.

The receiving unit 10 is provided with an A/D converter 11, a multi-carrier converter 12, an equalizer 13, a P/S converter 14, and a demapper 15. The A/D converter 11 converts an analog signal into digital data. The multi-carrier converter 12 is employed as a Fourier transformer (FFT), or a wavelet transformer (DWT) in order to perform a desirable time-to-frequency transforming operation. The equalizer 13 corrects a reception signal in such a manner that an adverse influence of a transmission path is canceled. The P/S converter 14 converts parallel data into serial data. The demapper 15 converts mapped symbol data into bit data corresponding to a reception signal.

The transmitting unit 20 is equipped with a symbol mapper 21, an S/P converter 22, an inverse multi-carrier converter 23, and a D/A converter 24. The symbol mapper 21 converts bit data corresponding to a transmission signal into symbol data so as to perform symbol mapping operation. The S/P converter 22 converts serial data into parallel data. The inverse multi-carrier converter 23 is employed as an inverse Fourier transformer (IFFT), or an inverse wavelet transformer (IDWT) in order to perform a desirable frequency-to-time transforming operation. The D/A converter 24 converts digital data into an analog signal.

The coupler 30 superimposes a signal derived from the transmitting unit 20 with respect to a power line 1 (refer to FIG. 15) via the power supply connector 102 as a power line communication-purpose signal, and also, extracts only a power line communication-purpose signal from the power line 1, and then, transmits the power line comnunication-purpose signal to the receiving unit 10.

The control unit 70 accepts an operation input entered from the operation unit 61, and controls entire units of the power line communication apparatus 100 such as the receiving unit 10, the transmitting unit 20, the RFID tag reader 40, the display unit 62, the storage unit 80, and the like. The storage unit 80 stores thereinto the communication setting information and the like as storage information.

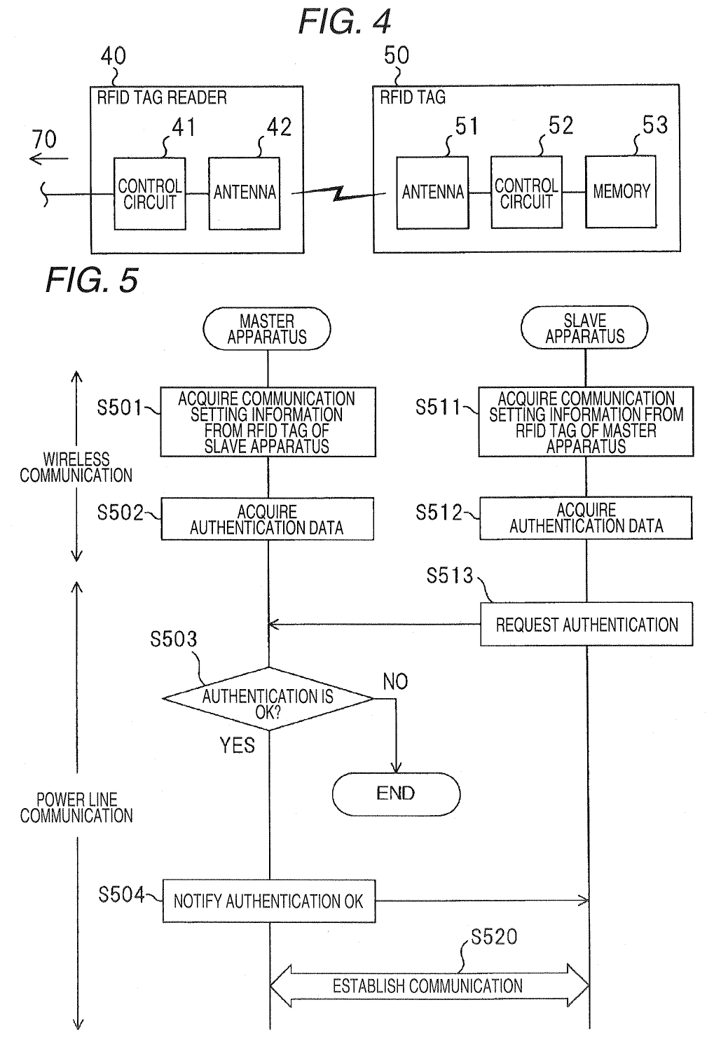

As indicated in FIG. 4, the RFID tag reader 40 contains a control circuit 41 and an antenna 42. The control circuit 41 has a wireless circuit and the like, which perform a wireless communication processing operation. The RFID tag 50 contains an antenna 51 such as a loop antenna, a control circuit 52, and a memory 53 which stores thereinto communication setting information. A rectifying circuit, or an oscillating circuit is connected to the antenna 51.

A description is made of such a case that as a wireless communication using the RFID tag reader 40, a frequency band of 13.56 MHz is employed. It should also be noted that the present invention is not limited only to 13.56 MHz, but may be applied to any other frequencies than 13.56 MHz if the employed frequency band belongs to the HF frequency band (3 to 30 MHz).

The RFID tag reader 40 superimposes information on either electromagnetic waves or magnetic fields by employing such a digital modulating system as an ASK (Amplitude Shift Keying) system, and then, transmits the superimposed information from the antenna 42. When the antenna 51 of the RFID tag 50 receives the transmitted information from the antenna 42 of the RFID tag reader 40, electric power is generated from the antenna 42 of the RFID tag 40, and thus, the generated electric power initiates the control circuit 52 and the memory 53. Then, the control circuit 52 reads out communication setting information from the memory 53, and superimposes the read communication setting information on magnetic fields generated by the electromagnetic induction so as to transmit the superimposed communication setting information via the antenna 51 to the RFID tag reader 40.

The RFID tag reader 40 receives either the electromagnetic waves or the magnetic fields transmitted from the RFID tag 50 by the antenna 42, and the control circuit 41 extracts therefrom the information so as to output the extracted information to the control unit 70. As previously described, the RFID tag reader 40 can read out the communication setting information stored in the RFID tag 50 provided on another power line communication apparatus.

As indicated in a flow chart of FIG. 5, the power line communication apparatus 100a (will be referred to as “master apparatus” hereinafter) which is operated as the master apparatus acquires communication setting information from the RFID tag 50x of the power line communication apparatus 100x (will be referred to as “slave apparatus” hereinafter) which is operated are the slave apparatus by employing the RFID tag reader 40a (step S501). The control unit 70 of the master apparatus 100a produces authentication data based upon the acquired communication setting information (step S502).

On the other hand, the slave apparatus 100x acquires communication setting information from the RFID tag 50a of the master apparatus 100a by employing the RFID tag reader 40x (step S511). The control unit 70 of the slave apparatus 100x produces authentication data based upon the acquired communication setting information (step S512). As described above, the communication setting information is acquired from the power line communication apparatus which constitutes the subject apparatus based upon the wireless communication with employment of the RFID tag reader 40 and the RFID tag 50.

Next, the control unit 70 of the slave apparatus 100x transmits an authentication request via both the transmitting unit 20 and the coupler 30 by employing the produced authentication data in accordance with the power line communication (step S513). When the control unit 70 of the master apparatus 100a receives the authentication request issued from the slave apparatus 100x via both the coupler 30 and the receiving unit 10 in accordance with the power line communication, the control unit 70 decides whether or not a connection of the master apparatus 100a with this slave apparatus 100x is permitted (step S503). As a result of this decision, in such a case where the authentication cannot be established, for instance, the authentication request is invalid, or the authentication request sent from the slave apparatus 100x is not received for a time period longer than, or equal to a predetermined time (“NO” in step S503), the authentication process operation is ended.

On the other hand, if the authentication request sent from the slave apparatus 100x is valid and the authentication can be established (YES in step S503), then the control unit 70 transmits a communication connectable response to the slave apparatus 100x via the transmitting unit 20 and the coupler 30. Then, the power line communication between the master apparatus 100a and the slave apparatus 100x is established (step S520).

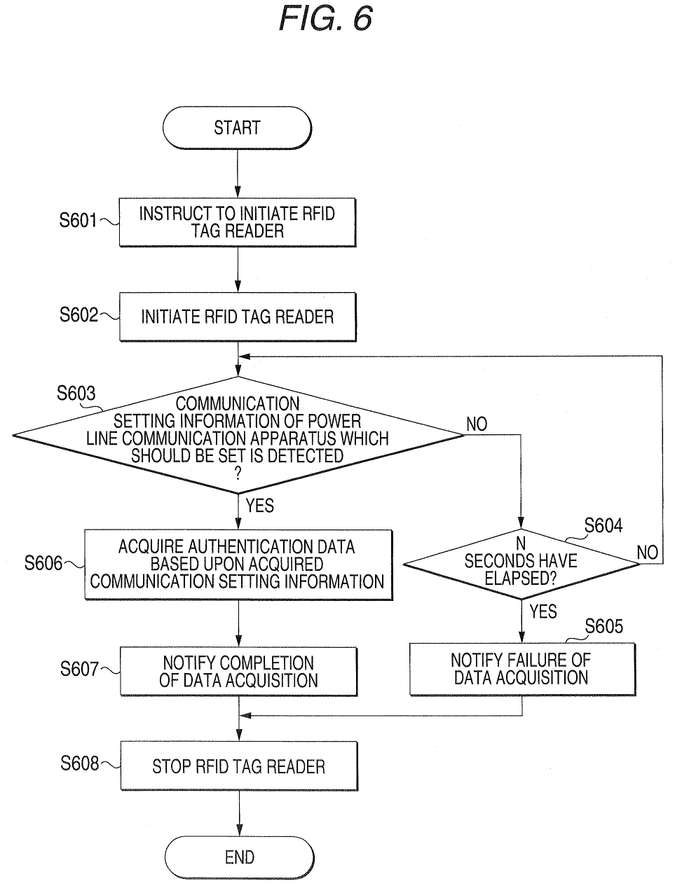

As shown in a flow chart of FIG. 6, when the control unit 70 detects an RFID tag reader initiating instruction which is produced when the operation unit 61 is depressed (step S601), the control unit 70 initiates the RFID tag reader 40 (step S602). It should also be noted that as a trigger for initiating the RFID tag reader 40, such an action occurred when the control unit 70 is connected to a power supply and thus a power line communication unit is initiated may be alternatively defined as the trigger.

Next, the control unit 70 decides whether or not a detection is made of the communication setting information stored in the RFID tag 50 of the power line communication apparatus which constitutes the subject apparatus by the RFID tag reader. 40 (step S603). In the case where the control unit 70 does not detect the communication setting information (“NO” in step S603), the control unit 70 decides whether or not a predetermined time of “N” seconds has elapsed after the RFID tag reader 40 was initiated (step S604). If the time for “N” seconds has not yet passed (“NO” of step S604), then the control unit 70 notifies such a fact that the acquisition of the communication setting information fails to the user by controlling the display unit 62, for example, by flickering the display unit 62 (step S605).

On the other hand, when the communication setting information is detected (“YES” in step S603), the control unit 70 acquires authentication data based upon the acquired communication setting information (step 606), and then, the control unit 70 notifies such a fact that the acquisition of the communication setting information is accomplished to the user by controlling the display unit 62, for example, by turning ON the display unit 62 (step S607). Then, the control unit 70 stops the RFID tag reader 40 (step S608).

It should also be noted that in the step S603, the control unit 70 may alternatively detect the communication setting information, and may alternatively decide whether or not the detected communication setting information is correct. For example, while a total number of data items of the communication setting information which are stored in the RFID tag 50a of the master apparatus 100a may be made different from a total number of data items of the communication setting information which are stored in the RFID tag 50x of the slave apparatus 100x, the control unit 70 may alternatively decide whether or not such a power line communication apparatus in which the RFID tag 50 for storing thereinto the acquired communication setting information has been provided corresponds to either the master apparatus or the slave apparatus based upon the acquired data item number in order to avoid that the communication setting process operation is carried out between the master apparatuses with each other, or between the slave apparatuses with each other.

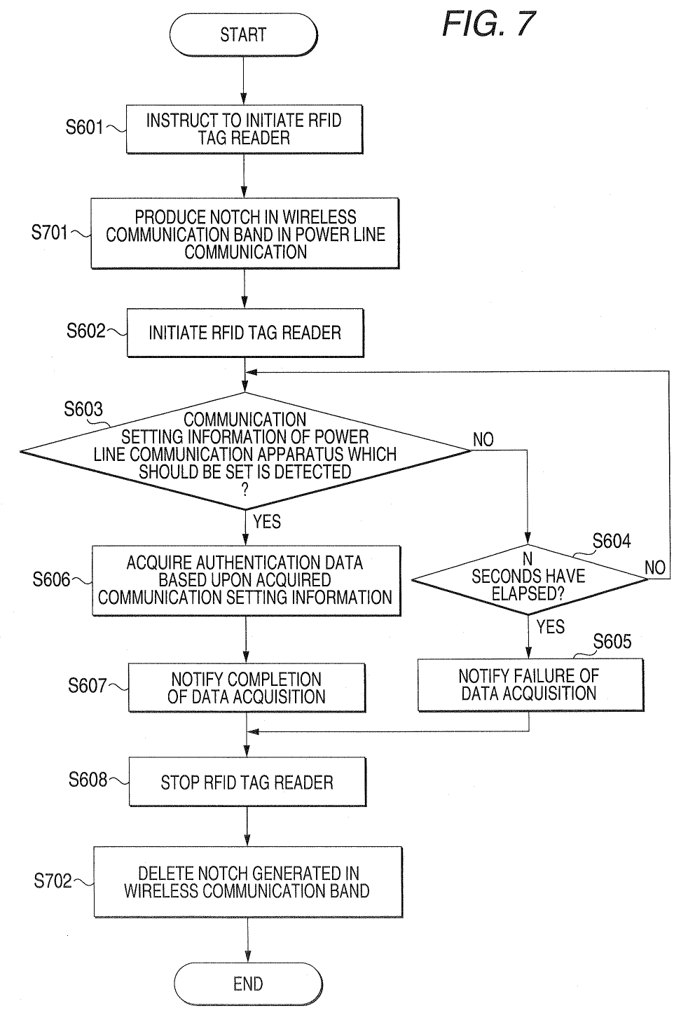

FIG. 7 shows a second example as to the process sequential operations related to the setting information acquisition with employment of the RFID tag reader 40. It should be noted that the same reference numerals shown in FIG. 6 will be employed as those for denoting the same process sequences.

In such a case where a wireless communication executed by employing the RFID tag reader 40 and a power line communication use the same frequency, radio interference may occur, and thus, there are some possibilities that sensitivities of mutual communications are deteriorated. For example, in the case where the frequencies of 2 to 30 MHz are used as the frequency band of the power line communication and the frequency of 13.56 MHz is employed in the wireless communication, the communications of both the power line communication and the wireless communication are carried out at the frequency of 13.56 MHz.

Under such a circumstance, the power line communication apparatus 100 masks a band as to a frequency position (namely, 13.56 MHz in case of above-described embodiment mode) of the wireless communication with respect to a communication signal which is sent out to a power line so as to produce a notch, and sends out a transmission signal containing the notch to the power line while the RFID tag reader 40 is initiated. It should also be understood that in this example, the frequency position of the wireless communication implies a position on the frequency axis, concretely speaking, implies either the frequency of the wireless communication or the band containing the frequency of the wireless communication. While no adverse influence is given to the power line communication, the setting operation of the power line communication can be carried out using the wireless communication.

As indicated in a flow chart of FIG. 7, when an initiation instruction of the RFID tag reader 40 is inputted (step S601), the control unit 70 controls the inverse multi-carrier converter 23 of the transmitting unit 20 so as to produce a notch by such a way that a sub-carrier corresponding to the frequency position of the notch to be provided (namely, sub-carrier is masked) in a step S701. Then, the control unit 70 sends out the transmission signal containing the notch in the frequency characteristic to the transmission path (power line 1) via the D/A converter 24 and the coupler 30. In this case, the multi-carrier converter 23 functions as a notch producing unit. Then, after the notch is produced in the power line communication signal the control unit 70 initiates the RFID tag reader 40 (step S602).

Then, when the RFID tag reader 40 is stopped in a step S608, the control unit 70 controls the inverse multi-carrier converter 23 so as to delete the production of the notch by using the sub-carrier which corresponds to the frequency position of the notch (step S702).

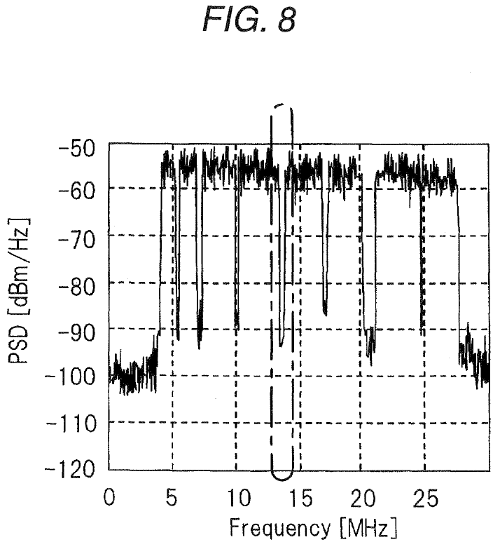

As represented in FIG. 8, when the FRID tag 40 is initiated, it can been seen that a notch 90 is provided at the frequency of 13.56 MHz which is employed in the wireless communication.

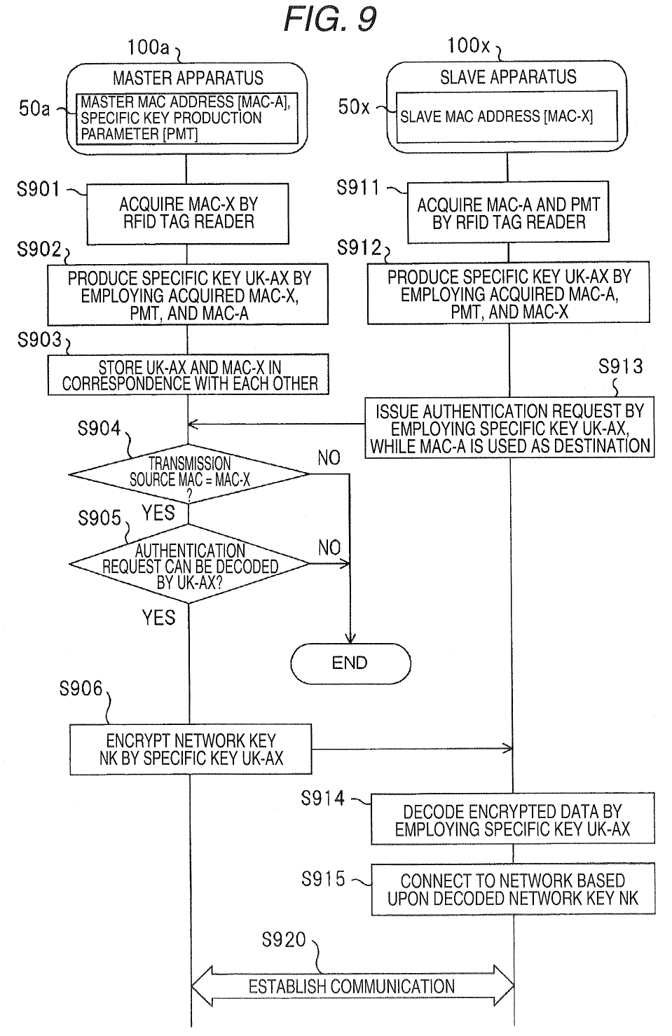

As shown in a flow chart of FIG. 9, in this example, as the communication setting information, a master apparatus MAC address “MAC-A” and a specific key production parameter “PMT” have been stored in the RFID tag 50a of the master apparatus 100a. The master apparatus MAC address MAC-A corresponds to an example of identification information which has been allocated to the own apparatus. The specific key production parameter PMT corresponds to one example of authentication-purpose information which is employed in a communication setting operation between the own communication apparatus and another communication apparatus. Also, slave apparatus MAC address MAC-X has been stored in the RFID tag 50x of the slave apparatus 100x. It should also be understood that the communication setting information stored in the RFID tag 50 installed in the own apparatus has been stored in the storing units 80 of the master apparatus 100a and of the slave apparatus 100x.

The master apparatus 100a acquires the slave apparatus MAC address MAC-X stored in the RFID tag 50x of the slave apparatus 100x by employing the RFID tag reader 40a (step S901). The control unit 70 of the master apparatus 100a produces a specific key UK-AX by employing the acquire slave apparatus MAC address MAC-X, and both the master MAC address MAC-A and the specific key production parameter PMT (step S902), while the master apparatus MAC address MAC-A corresponds to the MAC address of the own apparatus stored in the storage unit 80, and the specific key UK-AK corresponds to one example of the specific authentication data between the master apparatus 100a and the slave apparatus 100x. Then, the control unit 70 stores the produced specific key UK-AX into the storage unit 80 in correspondence with the slave apparatus MAC address MAC-X (step S903).

The slave apparatus 100x acquires the master apparatus MAC address MAC-A and the specific key production parameter PMT stored in the RFID tag 50a of the master apparatus 100a by employing the RFID tag reader 40x (step S911). The control unit 70 of the slave apparatus 100x produces a specific key UK-AX by employing the acquire master apparatus MAC address MAC-A and specific key production parameter PMT, and the slave apparatus MAC address MAC-X (step S912). The slave apparatus MAC address MAC-X corresponds to the MAC address of the own apparatus stored in the storage unit 80.

While the master apparatus MAC address MAC-A is employed as a destination, the slave apparatus 100x transmits an authentication request via the power line communication by employing the specific key UK-AX (step S913). The master apparatus 100a monitors the authentication request via the power line communication, and when the master apparatus 100a receives the authentication request, the master apparatus 100a decides whether or not a transmission source MAC address of the authentication request is equal to the stored slave apparatus MAC address MAC-X (step S904). Then, if the transmission source MAC address is equal to the slave apparatus MAC-X (“YES” of step S904), the master apparatus 100a reads out the specific key UK-AX stored in correspondence with the slave apparatus MAC address MAC-X in the step S903 from the storage unit 80, and decides whether or not the authentication request can be decoded (step S905).

It should also be understood that when the control unit 70 of the master apparatus 100a decides “NO” in the step S904, or the step S905, otherwise when the control unit 70 has not yet received the authentication request for a time duration longer than, or equal to a predetermined time, the control unit 70 accomplishes the authentication process operation, and notifies such a message that the authentication cannot be established by employing the display unit 62, or the like, if required.

When the authentication request is decoded by utilizing the specific key UK-AX in the step S905, the control unit 70 encrypts a network key “NK” corresponding to a key specific to the network based upon the specific key UK-AX, and then, transmits the encrypted specific key UK-AX to the slave apparatus 100x by the power line communication (step S906).

The slave apparatus 100x decodes the encrypted data which is transmitted from the master apparatus 100a by employing the specific key UK-AX (step S914), and is connected to the power line communication network by employing the decoded network key NK (step S915). Thus, a communication is established between the master apparatus 100a and the slave apparatus 100x in the above-described manner (step S920).

As previously described, in accordance with the first concrete example as to the authentication process operation, such a communication apparatus which should be set is identified by employing the MAC address so as to be authenticated, so that the communication setting operation with the high security characteristic can be carried out. Also, since the specific key is produced by using the specific key production parameter so as to perform the authentication of the communication apparatus to be set, the security characteristic can be further increased.

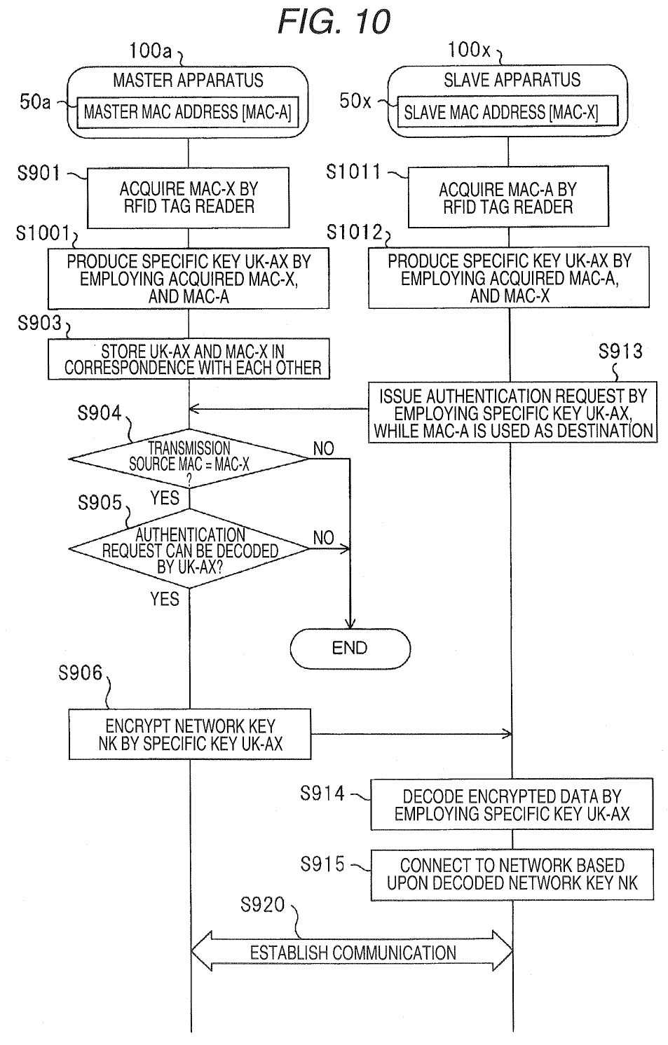

FIG. 10 is a sequential diagram for indicating a second concrete example as to the authentication process operation. It should be noted that the same reference numerals shown in FIG. 9 will be employed as those for denoting the same sequential process steps. In this second concrete example, the master apparatus MAC address MAC-A has been stored in the RFID tag 50a of the master apparatus 100a as the communication setting information, while the master apparatus MAC address MAC-A corresponds to one example of the identification information allocated to the own apparatus. Also, the slave apparatus MAC address MAC-X has been stored into the RFID tag 50x of the slave apparatus 100x.

When the master apparatus 100a acquires the slave apparatus MAC address MAC-X (step S901), the control unit 70 of the master apparatus 100a produces a specific key UK-AX by employing the acquire slave apparatus MAC address MAC-X, and the master MAC address MAC-A (step S1001). The master apparatus MAC address MAC-A corresponds to the MAC address of the own apparatus stored in the stored unit 80, and the specific key UK-AX corresponds to one example of the specific authentication data between the master apparatus 100a and the slave apparatus 100x.

When the slave apparatus 100x acquires the master apparatus MAC address MAC-A stored in the RFID tag 50a of the master apparatus 100a by employing the RFID tag reader 40x (step S1011), the control unit 70 of the slave apparatus 100x produces a specific key UK-AX by employing the acquire master apparatus MAC address MAC-A and the slave apparatus MAC address MAC-X (step S1012). The slave apparatus MAC address MAC-X corresponds to the MAC address of the own apparatus stored in the storage unit 80. The subsequent process operations are carried out in a similar manner to those described in FIG. 9.

As previously described, in accordance with the second concrete example as to the authentication process operation, since the specific key production parameter is produced by employing only the MAC address, the communication setting operation with the high security characteristic can be carried out in a simple manner.

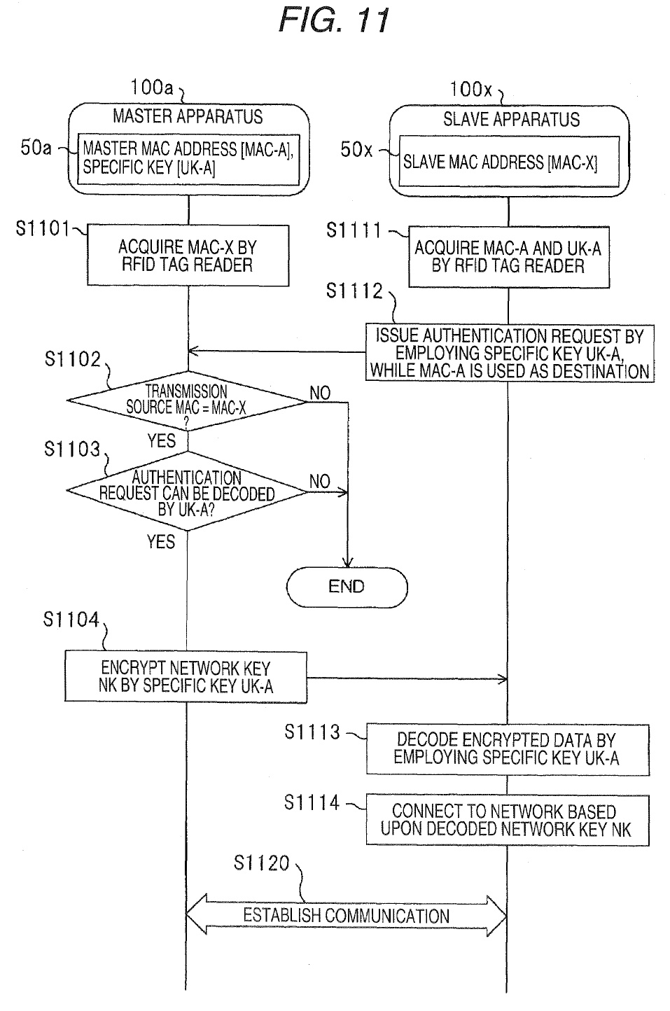

FIG. 11 is a sequential diagram for indicating a third concrete example as to the authentication process operation. As shown in FIG. 11, in this third concrete example, the master apparatus MAC address MAC-A and the specific key UK-A have been stored in the RFID tag 50a of the master apparatus 100a. The specific key UK-A corresponds to one example as to authentication-purpose information to be used in the communication setting operation, and has been specifically allocated to the master apparatus 100a. Also, the slave apparatus MAC address MAC-X has been stored in the RFID tag 50x of the slave apparatus 100x.

The master apparatus 100a acquires the slave apparatus MAC address MAC-X stored in the RFID tag 50x of the slave apparatus 100x by employing the RFID tag reader 40a (step S1101).

The slave apparatus 100x acquires the master apparatus MAC address MAC-A and a specific key UK-A stored in the RFID tag 50a of the master apparatus 100a by employing the RFID tag reader 40x (step S1111). Then, while the master apparatus MAC address MAC-A is employed as a destination, the slave apparatus 100x transmits an authentication request via the power line communication by employing the specific key UK-A (step S1112).

The master apparatus 100a monitors the authentication request via the power line communication, and when the master apparatus 100a receives the authentication request, the master apparatus 100a decides whether or not a transmission source MAC address of the authentication request is equal to the stored slave apparatus MAC address MAC-X (step S1102). Then, if the transmission source MAC address is equal to the slave apparatus MAC-X (“YES” of step S1102), the master apparatus 100a reads out the specific key UK-A from the storage unit 80, and decides whether or not the authentication request can be decoded (step S1103).

It should also be understood that when the control unit 70 of the master apparatus 100a decides “NO” in the step S1102, or the step S103, otherwise when the control unit 70 has not yet received the authentication request for a time duration longer than, or equal to a predetermined time, the control unit 70 accomplishes the authentication process operation, and notifies such a message that the authentication cannot be established by employing the display unit 62, or the like, if required.

When the authentication request is decoded by utilizing the specific key UK-A in the step S1103, the control unit 70 encrypts a network key “NK” corresponding to a key specific to the network based upon the specific key UK-A, and then, transmits the encrypted specific key UK-A to the slave apparatus 100x by the power line communication (step S1104).

The slave apparatus 100x decodes the encrypted data which is transmitted from the master apparatus 100a by employing the specific key UK-A (step S1113), and is connected to the power line communication network by employing the decoded network key NK (step S1114). Thus, a communication is established between the master apparatus 100a and the slave apparatus 100x in the above-described manner (step S1120).

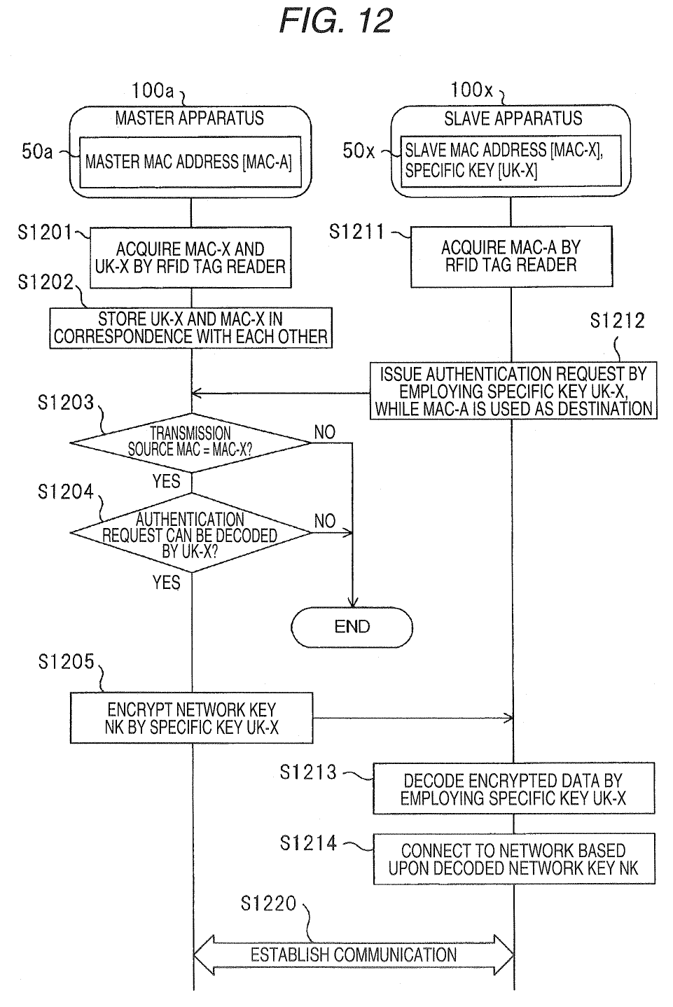

As shown in a flow chart of FIG. 12, in this example, the master apparatus MAX address MAC-A has been stored in the RFID tag 50a of the master apparatus 100a. Also, both the slave apparatus MAC address MAC-X and a specific key UK-X have been stored in the RFID tag 50x of the slave apparatus 100x. The specific key UK-X has been specifically allocated to the slave apparatus 100x, and corresponds to one example of authentication-purpose information which is employed in the communication setting operation.

The master apparatus 100a acquires the slave apparatus MAC address MAC-X and the specific key UK-X stored in the RFID tag 50x of the slave apparatus 100x by employing the RFID tag reader 40a (step S1201). Then, the master apparatus 100a stores the slave apparatus MAC address MAC-X and the specific key UK-X into the storage unit 80 in correspondence with each other (step S1202).

The slave apparatus 100x acquires the master apparatus MAC address MAC-A and stored in the RFID tag 50a of the master apparatus 100a by employing the RFID tag reader 40x (step S1211). Then, while the master apparatus MAC address MAC-A is employed as a destination, the slave apparatus 100x transmits an authentication request via the power line communication by employing the specific key UK-X stored in the storage unit 80 (step S1212).

The master apparatus 100a monitors the authentication request via the power line communication, and when the master apparatus 100a receives the authentication request, the master apparatus 100a decides whether or not a transmission source MAC address of the authentication request is equal to the stored slave apparatus MAC address MAC-X (step S1203). Then, if the transmission source MAC address is equal to the slave apparatus MAC-X (“YES” of step S1203), the master apparatus 100a reads out the specific key UK-X stored in correspondence with the slave apparatus MAC address MAC-X in the step S1202 from the storage unit 80, and decides whether or not the authentication request can be decoded (step S1204).

It should also be understood that when the control unit 70 of the master apparatus 100a decides “NO” in the step S1203, or the step S1204, otherwise when the control unit 70 has not yet received the authentication request for a time duration longer than, or equal to a predetermined time, the control unit 70 accomplishes the authentication process operation, and notifies such a message that the authentication cannot be established by employing the display unit 62, or the like, if required.

When the authentication request is decoded by utilizing the specific key UK-X in the step S1204, the control unit 70 encrypts a network key “NK” corresponding to a key specific to the network based upon the specific key UK-X, and then, transmits the encrypted specific key UK-X to the slave apparatus 100x by the power line communication (step S1205).

The slave apparatus 100x decodes the encrypted data which is transmitted from the master apparatus 100a by employing the specific key UK-X (step S1213), and is connected to the power line communication network by employing the decoded network key NK (step S1214). Thus, a communication is established between the master apparatus 100a and the slave apparatus 100x in the above-described manner (step S1220).

As previously described, in accordance with the third and fourth concrete examples as to the authentication process operation, such a communication apparatus which should be set is identified by employing the MAC address so as to be authenticated, so that the communication setting operation with the high security characteristic can be carried out. Also, the specific key is transmitted and received between the master apparatus and the slave apparatus so as to perform the authentication, so that the security characteristic can be simply increased.

In the above-described third and fourth concrete examples of the authentication process operations, the specific key held by any one of the master apparatus 100a and the slave apparatus 100x and is transmitted to the other. Alternatively, while both the master apparatus 100a and the slave apparatus 100x may hold the specific keys respectively, these specific keys may be mutually transmitted and received.

In the above-described examples, the authentication process operation is carried out by utilizing both the identification information and the authentication-purpose information as the communication setting information. Alternatively, any one of the identification and authentication-purpose information may be utilized so as to perform the authentication process operation.

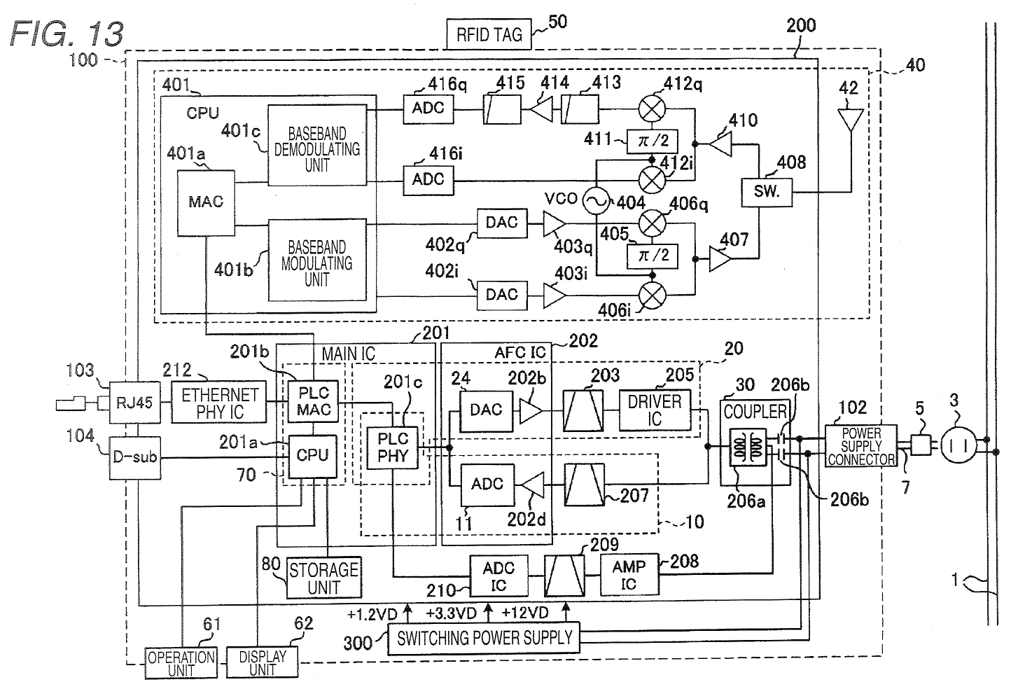

FIG. 13 is a block diagram for indicating one example of hardware as to the above-explained power line communication apparatus. It should be understood that the same reference numerals shown in FIG. 13 will be employed as those for denoting the same structural units of FIG. 3 and FIG. 4. It should also be noted that for the sake of easy understandings of the present invention, as to the communication apparatus 100 of FIG. 3 and the RFID tag reader 40 of FIG. 4, only major elements among the elements of the hardware block diagram shown in FIG. 13 are illustrated.

As indicated in FIG. 13, the communication apparatus 100 contains a circuit module 200 and a switching power supply 300. The switching power supply 300 applies voltages of +1.2 V, +3.3 V, and +12 V to the circuit module 200.

The power supply connector 102 is connected to the circuit module 200 and the switching power supply 300. The AC power supply cord 7 is connected to the power supply connector 102, and a power supply adapter having the power supply plug 5 is provided on one end of the AC power supply cord 7. The power supply plug 5 is constructed in such a manner that this power supply plug 5 may be freely inserted into a plug socket insertion port 3 such as a wall plug socket insertion port.

In the circuit module 200, an main IC (Integrated Circuit) 201, an AFE•IC (Among Front End IC) 202, a band-pass filter (will be referred to as “BPF” hereinafter) 203, a driver IC 205, a coupler 30, another BPF 207, an AMP (amplifier)•IC 208, another PBF 209, an ADC (A/D converting)•IC 210, a storage unit 80, an Ethernet® physical layer IC (PHYIC) 212 are provided.

The main IC 201 is arranged by containing a CPU (Central Processing Unit) 201a, a PLC•MAC (Media Access Control) block 201b, and a PLC•PHY (Power Line Communication•Physical layer) block 201c.

The PLC•MAC block 201b of the main IC 201 is connected via the Ethernet® PHY (Physical layer)≮IC 212 to the modular jack 103. The CPU 201a of the main IC 201 is connected to the D-SUB connector 104, the storage unit 80, the operation unit 61, and the display unit 62.

It should also be noted that in the main IC 201, both the CPU 201a and the PLC•MAC block 201b have the function of the control unit 70, whereas the PLC•PHY block 201c has the functions as to the multi-carrier converter 12, the equalizer 13, the P/C converter 14, the demapper 15, the symbol mapper 21, the S/P converter 22, and the inverse multi-carrier converter 23.

The AFE•IC 202 is arranged by containing the D/A converter (DAC) 24, the amplifier 202b, A/D converter (ADC) 11, and the amplifier 202b. The coupler 30 is arranged by a coil transformer 206a and a capacitor 206b.

The receiving unit 10 is arranged by containing such circuit elements as the BPF 207, the amplifier 202d, and the A/D converter 11 in addition to the PLC•PHY block. Also, the transmitting unit 20 is arranged by containing such circuit elements as the D/A converter 24, the amplifier 202b, the BPF 203, and the driver IC 205 in addition to the PLC•PHY block.

Furthermore, a circuit which functions as the RFID tag reader 40 is provided in the circuit module 200. The above-described circuit contains a MAC 401a, a CPU 401 containing both a baseband modulating unit 401b and a baseband demodulating unit 401c, a voltage-controlled oscillator 404, a switch 408 for switching a transmission and a reception, and an antenna 409. Also, D/A converters (DAC) 402i and 402q; amplifiers 403i and 403q; a phase shifter 405; mixers 406i and 406q; and an amplifier 407 are provided as a transmission system on the output side of the baseband modulating unit 401. Also, an amplifier 410, a phase shifter 411, mixers 412i and 412q, a high-pass filter (will be referred as “HPF” hereinafter) 413, another amplifier 414, another HPF 415, and A/D converters (ADC) 416i and 416q are provided as a reception system.

The above-described circuit elements defined from the CPU 401 to the switch 408 except for the antenna 42, and from the amplifier 410 to the A/D converter 416 are operated as the control unit 41 of the RFID tag reader 40 shown in FIG. 4.

In the embodiment mode of the present invention, as the PLC, such a communication system which performs the multi-carrier communication type broadband communication (2 to 30 MHz) has been exemplified. However, the communication system of the present invention is not limited to the multi-carrier communication system, but may be alternatively carried out in accordance with a single carrier communication system, or a spread spectrum system. In this alternative case, a notch filter may be alternatively used as the notch producing unit.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

The present invention has an effect that the power line communication can be readily set, and can be advantageously applied to power line communication apparatuses, power line communication systems, and the like.

This application is based upon and claims the benefit of priority of Japanese Patent Application No. 2006-032484 filed on Feb. 9, 2006, the contents of which are incorporated herein by reference in its entirety.

What is claimed is:

1. A power line communication apparatus comprising:
a power line communication unit for performing a power line communication with another power line communication apparatus via a power line; and
a near-field communication unit for performing a near-field communication by employing any one of electromagnetic waves and a magnetic field,
wherein said near-field communication unit includes a memory for storing thereinto communication setting information which is employed in a process authenticating with said another power line communication apparatus.

2. A power line communication apparatus as claimed in claim 1, wherein said near-field communication unit performs the near-field communication by employing a magnetic field of an HF (High Frequency) band.

3. A power line communication apparatus as claimed in claim 2, wherein said near-field communication unit performs the near-field communication by employing a magnetic field of a 13.56 MHz band.

4. A power line communication apparatus as claimed in claim 1, wherein said near-field communication unit performs the near-field communication by employing electromagnetic waves of a UHF (Ultra High Frequency) band.

5. A power line communication apparatus as claimed in claim 4, wherein said near-field communication unit performs the near-field communication by employing electromagnetic waves of a 900 MHz band.

6. A power line communication apparatus as claimed in claim 1, wherein said power line communication unit issues a communication connection request with respect to another power line communication apparatus by employing said communication setting information.

7. A power line communication apparatus as claimed in claim 6, further comprising:
a storage unit for storing thereinto said communication setting information as storage information;
wherein said power line communication unit issues a communication connection request with respect to another power line communication apparatus by employing said storage information.

8. A power line communication apparatus as claimed in claim 1, wherein said power line communication unit decides whether or not the own power line communication apparatus can be connected to another power line communication apparatus by employing said communication setting information.

9. A power line communication apparatus as claimed in claim 1, further comprising:
a storage unit for storing thereinto said communication setting information as storage information;
wherein said power line communication unit decides whether or not the own power line communication apparatus can be connected to another power line communication apparatus by employing said communication setting information in such a case that said power line communication unit receives a communication connection request issued from said another power line communication apparatus.

10. A power line communication apparatus as claimed in claim 1, wherein said communication setting information contains specific identification information.

11. A power line communication apparatus as claimed in claim 10, wherein said identification information corresponds to address information.

12. A power line communication apparatus as claimed in claim 1, wherein said communication setting information contains authentication-purpose information which is employed in a communication setting operation with respect to another power line communication apparatus.

13. A power line communication apparatus as claimed in claim 12, wherein said authentication-purpose information corresponds to a specific key production parameter.

14. A power line communication apparatus as claimed in claim 1, further comprising:
a housing having an outer surface on which an identifying unit is provided at a position having a predetermined relationship with such a position where said near-field communication unit is mounted.

15. A power line communication apparatus as claimed in claim 1, wherein said near-field communication unit is provided outside said power line communication unit.

16. A power line communication apparatus comprising:
a reader having an antenna, for reading information stored in a near-field communication unit via said antenna by way of a near-field communication using any one of electromagnetic waves and a magnetic field; and
a power line communication unit for performing a power line communication via a power line,
wherein when communication setting information related to another power line communication apparatus is read by said reader from a near-field communication unit mounted on said another power line communication apparatus, said power line communication unit performs a power line communication operation with respect to said another power line communication apparatus based upon said read communication setting information.

17. A power line communication apparatus as claimed in claim 16, wherein said power line communication unit issues a communication connection request with respect to another power line communication apparatus by employing communication setting information read by said reader.

18. A power line communication apparatus as claimed in claim 16, wherein said power line communication unit decides whether or not the own power line communication apparatus can be connected to another power line communication apparatus which issues said connection request based upon the communication setting information read by said reader in such a case that said power line communication unit receives a communication connection request from an external unit.

19. A power line communication apparatus as claimed in claim 16, wherein the communication setting information read by said reader contains identification information allocated to said another power line communication apparatus.

20. A power line communication apparatus as claimed in claim 19, wherein said identification information corresponds to address information.

21. A power line communication apparatus as claimed in claim 19, wherein said power line communication unit performs a communication setting operation with respect to said another power line communication apparatus, while the identification information contained in said communication setting information is used as a destination.

22. A power line communication apparatus as claimed in claim 19, wherein in the case that the communication request is received from the external unit, the power line communication unit decides whether or not the own power line communication apparatus can be connected to the power line communication apparatus which issues said connection request in response to a comparison result obtained by comparing identification information of a transmission source of said connection request with identification information of another power line communication read by said reader.

23. A power line communication apparatus as claimed in claim 16, wherein said communication setting information read by said reader contains authentication-purpose information which has been specifically allocated to said another power line communication apparatus and is employed in the communication setting operation.

24. A power line communication apparatus as claimed in claim 23, wherein said authentication-purpose information corresponds to a specific key production parameter.

25. A power line communication apparatus as claimed in claim 23, wherein said power line communication unit performs the communication setting operation with respect to said another power line communication apparatus by employing the authentication-purpose information contained in said communication setting information.

26. A power line communication apparatus as claimed in claim 16, wherein said power line communication unit produces specific authentication data between the own power line communication apparatus and said another power line communication apparatus by employing both the identification information of said another power line communication apparatus read by said reader and identification information allocated to the own power line communication apparatus, and performs a communication setting operation with respect to said another power line communication apparatus by employing said produced authentication data.

27. A power line communication apparatus as claimed in claim 16, wherein said power line communication unit includes a notch producing unit for producing a notch by masking a band of a frequency position employed in a wireless communication operation performed by said reader, and sends out a transmission signal containing said notch to a transmission path while said reader is initiated.

28. A power line communication apparatus as claimed in claim 16, further comprising:
a housing having an outer surface on which an identifying unit is provided at a position having a predetermined relationship with such a position where said near-field communication unit is mounted.

29. A power line communication apparatus as claimed in claim 16, further comprising:
a near-field communication unit for storing thereinto the communication setting information employed when said power line communication unit performs the power line communication operation.

30. A power line communication apparatus as claimed in claim 29, wherein in such a case that said power line communication apparatus is operated as a master apparatus, said near-field communication unit and said reader are installed at a first position and a second position which is different from said first position respectively; whereas in such a case that said power line communication apparatus is operated as a slave apparatus, said near-field communication unit and said reader is installed at said second position and said first position respectively.

31. A power line communication apparatus as claimed in claim 15, wherein said near-field communication unit is provided outside said power line communication unit.

32. A power line communication system comprising:
a first power line communication apparatus and a second power line communication apparatus, which perform a power line communication operation via a power line,
wherein said first power line communication apparatus includes:
a first power line communication unit for performing a power line communication operation via the power line; and
a near-field communication unit for storing thereinto communication setting information which is employed when said first power line communication unit performs the power line communication operation; and
wherein said second power line communication apparatus includes:
a reader having an antenna, for reading information stored in the near-field communication unit via said antenna by employing a wireless communication operation; and
a second power line communication unit for performing a power line communication operation via the power line;
when the communication setting information employed in such a case that said first power line communication apparatus performs the power line communication operation is read out from the near-field communication unit mounted on said first power line communication apparatus by said reader, said second power line communication unit performs the power line communication operation with said first power line communication apparatus based upon said communication setting information.
